(19) United States
(12) Patent Application Publication
(10) Pub. No.: US 2005/0015538 A1
(43) Pub. Date: Jan. 20, 2005

(54) Method for addressing a memory

(76) Inventors: Cornelis Van't Wout, Naaldwijk (NL); Peter Casper Rutger Beukelman, Den Haag (NL)

Correspondence Address: Webb Ziesenheim Logsdon Orkin & Hanson, 700 Koppers Building, 436 Seventh Avenue, Pittsburgh, PA, 15219-1818, US

(21) Appl. No.: 10/498,410

(22) PCT Filed: Dec. 12, 2002
(86) PCT No.: PCT/NL02/00819

(30) Foreign Application Priority Data
Dec. 12, 2001 (NL) 1019546

(51) Int. Cl. G06F 12/00

(52) U.S. Cl. 711/5; 711/170; 711/105

(57) ABSTRACT

A method for addressing a random access memory for writing data to the memory and reading data from the memory. The memory includes at least one bank, a plurality of rows and a plurality of columns. The manner for writing data to the memory and the manner for reading data from the memory are carried out according to a first or a second addressing type, wherein the addressing type for writing and reading is selected on the basis of parameters of the data and the processing which is to be carried out on the data. The data processing includes transposition of a data matrix, and the data are written to the memory with the aid of burst mode addressing, and the data are read from the memory with the aid of open-row addressing.

The present invention relates to a method for addressing a random access memory for writing data to the memory and reading data from the memory, in which the memory comprises at least two banks, a plurality of rows and a plurality of columns.

European patent application EP-A-0 959 428 describes an image-processing device, in which a specific memory addressing method is used to write to and read from a memory. Video data comprising Y, C and K components with a data width of 32 bits are entered in parallel into the device and are rearranged into video data with Y, C and K components in series at each sampling point with a data width of 10 bits. These data are written out in a horizontal direction as a burst into an SDRAM (synchronous dynamic random access memory) with a burst length of four. For each sampling point, exchange from the bank in the SDRAM is effected in such a way that pixels adjacent to one another are always stored in different banks. In each bank, each component (Y, C, K) is given a consecutive address (n, n+1, n+2). Through alternate switching of the banks during memory read-out, data can be read in burst mode in the horizontal or vertical direction, to be rearranged in the horizontal or vertical direction. The described method therefore groups data associated with one pixel (10 bits Y, C and K data and two dummy bits), and stores these in burst mode alternately in one bank and the other bank of a memory in such a way that adjacent pixels are stored in different banks. This enables data associated with one pixel to be read out at high speed (in burst mode) in both the horizontal and vertical directions.

Due to the required multiplexing of the input signal (and demultiplexing of the read signal), a difference exists between the data speed of the input signal and the data speed required for the memory. Furthermore, the described method requires only one type of addressing in order to access a memory (burst mode addressing).

It is currently obvious to prefer memories of the dynamic type (DRAM) over memories of the static type (SRAM) for all sorts of applications. The reason for this is that DRAM is available in larger sizes (a plurality of Mbits per chip) than SRAM, and DRAM is less expensive than SRAM (by a factor of 100 per Mbit), since DRAM is used in PCs. The disadvantage of memories of the DRAM type is that high-speed access is restricted to normal addressing schemes such as linear addressing. The use of random access in DRAM memories results in reduced performance. Furthermore, the dynamic nature of DRAM requires that each memory bit is periodically refreshed, since data are otherwise lost. This refreshing of data in the memory requires additional control operations, since the refresh process interferes in most cases with the addressing schemes which are used.

The present invention is intended to provide a method for memory addressing and a dynamic memory with which a dynamic random access memory (DRAM) can be used in an efficient manner for high-speed reading and writing of data from the memory in a random sequence with no loss of performance. In addition, the present invention intends to produce a method for refreshing a DRAM which has minimal impact on the high-speed random read-out from the DRAM.

According to the present invention, a method of the type defined in the preamble is produced, in which the manner of writing data to the memory and the manner of reading data from the memory are carried out according to a first or a second addressing type, and in which the addressing type for writing and reading is selected on the basis of parameters of the data and the processing which is to be carried out on the data.

The present method enables memories to be written to and read from in a highly efficient and fast manner. The writing of data to and the reading of data from a memory can be optimised for a specific application by making maximum use of two different addressing methods. The application is characterised by the parameters of the data and the operation which is to be carried out. The present method can be used in particular in applications wherein the sequence of large data sets is manipulated, such as in image processing, video processing, radar, medical applications, etc.

In a further embodiment of the present invention, the method further comprises the steps of checking whether the memory is busy performing a read or write operation; if so, waiting until the read or write operation can be interrupted, row-by-row refresh of the memory and continuation of the interrupted read or write operation.

This produces a highly efficient method for refreshing the data stored in a memory without reducing the efficiency of the addressing, by minimising the required additional control operations (overhead). The refresh is deferred as far as possible until the time when it does not interfere with the primary process (the reading from or writing to the memory).

In one embodiment, the first addressing type may be burst mode addressing with a burst length of Q memory spaces, comprising the steps of the opening of a row of the memory and the addressing of Q memory spaces in that row by selecting a bank and a start column. This is particularly advantageous if a large amount of data needs to be made available on consecutive spaces in the memory for a specific application. The burst length Q may, for example, be 4, 8, 16 or infinity.

Furthermore, consecutive burst sequences may be addressed to different banks of the at least one bank, thereby ensuring high-speed access to the memory.

In an advantageous embodiment, the burst length Q is greater than the latency L1 which is required in order to open a row in the memory. This offers optimal utilisation of the data read-out.

In a further embodiment, the method further comprises the steps of the closing of a current row, the activation of a following row and the selection of a series of memory spaces at a time when the content of memory spaces of the current row is available at the output of the memory. Through these parallel addressing steps, less time is lost in accessing specific memory spaces in the memory, thereby increasing the average speed for accessing the memory. The time is selected, for example, in such a way that the first memory space of a following row is available immediately after the last memory space of the current row. By using a fixed burst length Q for a specific application, this is simple to implement as the latencies of the different steps in the addressing are defined (are dependent on the memory configuration).

The second addressing type comprises open-row addressing, which comprises the steps of the opening of a combination of a bank and a row and the accessing of a plurality of memory spaces in that row through sequential selection of a plurality of columns. Once a row is open, no additional latency is required in order to access further memory spaces in the same row. The efficiency of the memory can thus be increased through appropriate use of this addressing type in a specific application.

The random access memory may be a memory which is selected from the group comprising dynamic memories (DRAM), synchronous dynamic memories (SDRAM), dynamic memories with double data rate (DDR-DRAM), and Rambus memories (RDRAM).

In one embodiment, the data processing comprises transposition of a data matrix. The data are written to the memory with the aid of burst mode addressing, and the data are read from the memory with the aid of open-row addressing. This enables highly efficient transposition of the data matrix.

In a further aspect, the present invention relates to an addressing device for a random access memory with at least one bank, a plurality of rows and a plurality of columns, in which the addressing means are arranged to carry out the method according to the present invention. The addressing means may be implemented in separate hardware components, or may be integrated into the memory itself.

In a still further aspect, the present invention relates to a dynamic random access memory comprising at least one bank, a plurality of rows and a plurality of columns, further comprising a priority control which is linked to a refresh control, and a memory control which is linked to the refresh control, in which the priority control has at least an idle mode, a read/write mode and a read/write interrupt mode, the refresh control being arranged for the periodic transmission of a refresh request to the priority control and the despatch of a refresh command to the memory control if the priority control is set to idle mode or read/write interrupt mode, in which the priority control is set to read/write interrupt mode if the read/write operation can be interrupted in read/write mode following receipt of a refresh request.

This implementation of the refreshing of a dynamic memory is highly effective and makes it possible to ensure refreshing of a memory, whereby no data will be lost from the memory.

The present invention will now be explained with reference to a number of embodiments and to the attached drawings, in which:

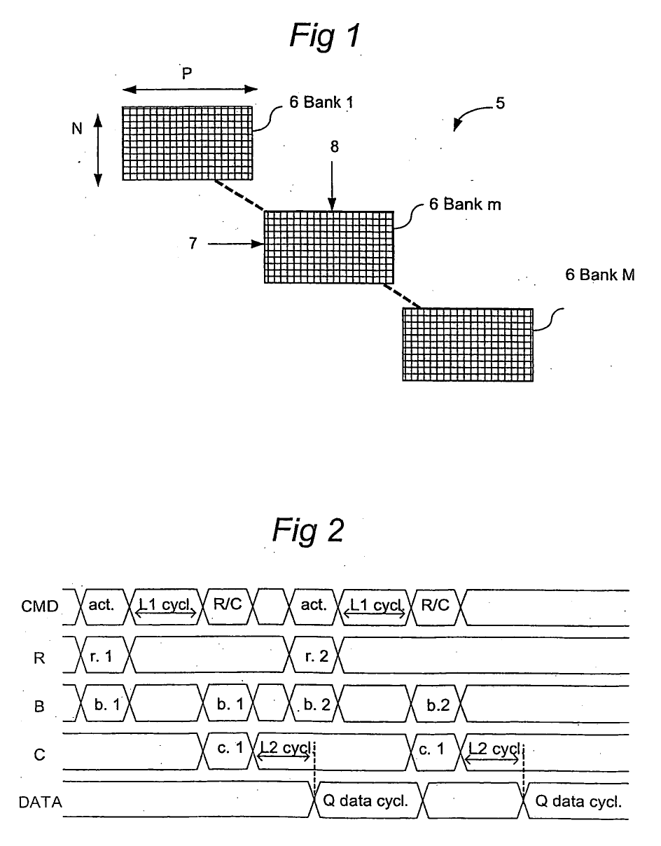

FIG. 1 shows a schematic illustration of a dynamic random access memory in which the present invention can be applied;

FIG. 2 shows a timing schedule for controlling the memory according to an embodiment of the present invention;

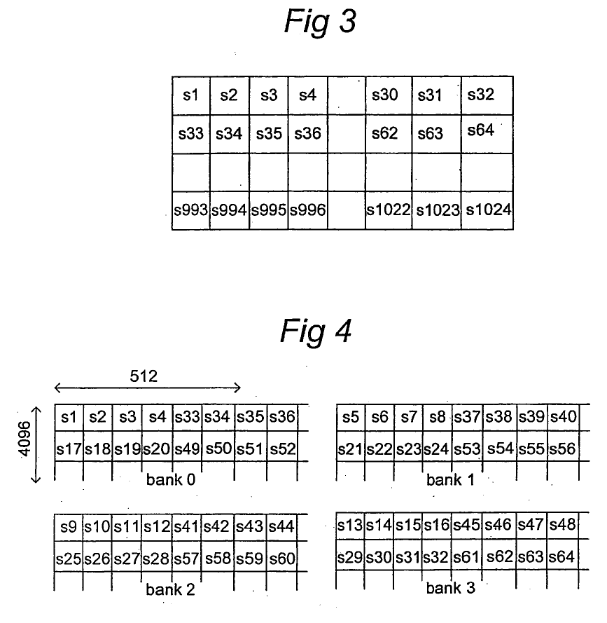

FIG. 3 shows a sample sequence of a 32×32 pixel image;

FIG. 4 shows a sample sequence of the 32×32 pixel image in FIG. 3 after having been stored in a memory according to the present method;

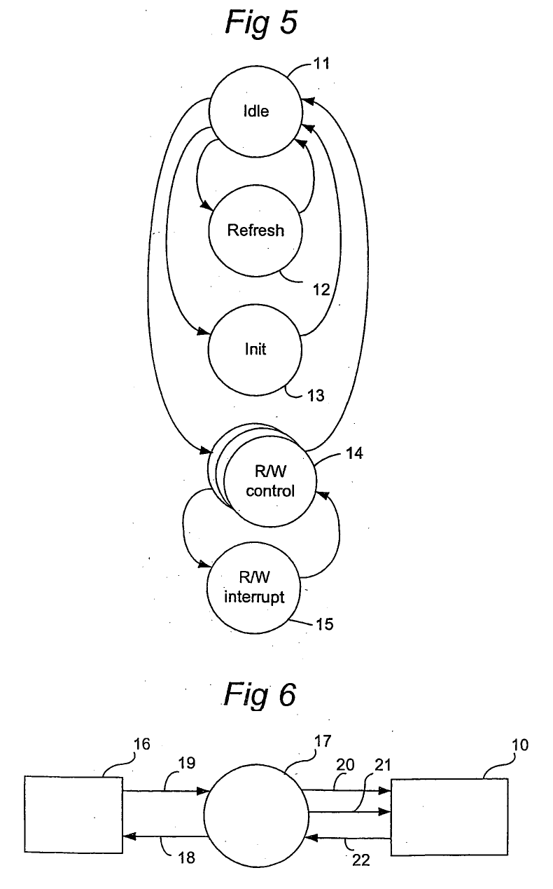

FIG. 5 shows a status diagram of a priority control in an embodiment of the present invention;

FIG. 6 shows a context diagram of the priority control in FIG. 5.

A dynamic random access memory (DRAM) 5, as shown schematically in FIG. 1, generally comprises M banks 6, in which each bank comprises N rows 7, and each row has P memory spaces 8 (also referred to as columns). Each memory space can be addressed in a unique manner and may comprise one word (this may be 8 bits or 16 bits, depending on the memory type). The memory size of a DRAM 5 is therefore M×N×P words. Typical values are M=4, N=4096 and P=512.

Before a memory space in a specific bank m can be read from or written to, the relevant row n 7 must be opened. The opening of a row 7 is achieved by an ‘activate’ command which selects a specific row address and a bank 6. After a latency of L1 clock cycles (generally L1=2), a ‘read’ command selects the column p 8 of that row 7. After a latency of L2 clock cycles (generally L2=2), the memory space is available at the output of the memory 5. A ‘write’ command is correspondingly used to write to a memory space. The reading of memory addresses can similarly be understood below to refer correspondingly in each case to the writing of memory addresses.

If the following memory space is located in the same row 7, this row 7 can be kept open. The ‘read’ command for a different memory space in the same row can be given immediately following the preceding ‘read’ command, and these data are then available at the output immediately after the previous data.

If the following memory space is not located in the same row 7, the current row 7 must first be closed with the aid of a ‘close’ command, which can be given simultaneously with the last ‘read’ command. Once the current row 7 is closed, the following row 7 can be opened in the same way as described above.

It is similarly possible to read consecutive memory spaces in the same row 7 in burst mode. This generally means that the memory spaces p, p+1, . . . , p+Q−1 are read following a ‘read’ command in burst mode. The length of the burst (reading or writing) may be Q memory spaces, where Q is generally equal to 4, 8, 16 or infinity. FIG. 2 shows the time diagram for accessing two consecutive data bursts in two different rows 7.

The above rule represents the command line CMD, which can comprise commands (READ, READ in burst mode, CLOSE, or inactive). In the lines below, the signals which are used represent the selection of a row (R), a bank (B) and a column (C). The final line indicates whether specific memory spaces are available at the output of the memory.

The advantage of reading and writing in burst mode is that the command bus CMD and address buses R, B, C are available, for example, for opening a following row 7 in a different bank 6. The current row 7 can then be closed at the same time as the ‘read’ command, and the following row 7 can already be activated during the current access to the burst data. It is thereby in principle possible to obtain the following burst data immediately after the current burst data. FIG. 2 shows, for example, that the memory spaces D1 of bank 1 and column 1 are available L2 cycles after the ‘read’ and ‘close’ command. The ‘activate’ command for the following row (R2) is given immediately after the ‘read’ and ‘close’ command. Only later is the ‘read in burst mode’ command given for reading from the memory spaces D2 in bank 2 and column 2 in row 2.

In order to prevent data loss in dynamic memories 5, each row in the memory 5 must be refreshed once every T μsec. In practice, this means that a ‘read’ or ‘write’ command or a ‘refresh’ command must be given at an interval of T μsec. The ‘refresh’ command refreshes a row 7 in all banks 6 simultaneously. The memory 5 remembers which row 7 was the last to be refreshed and the following row 7 is selected after a following ‘refresh’ command. The refreshing of a row 7 requires a latency of L3 clock cycles, where L3 is generally equal to seven. The refreshing of memory spaces with the ‘refresh’ commands can interfere with the addressing of the memory 5 in order to read or write data.

According to the present invention, memory spaces in a DRAM 5 are quickly accessible with two levels of freedom. The levels of freedom relate to freedom in terms of column addressing, and freedom in terms of row addressing. Quickly accessible means that the access frequency is close to one access of a memory space per clock cycle, even if memory spaces are located in a plurality of rows.

The present method uses two types of addressing (both for reading from and writing to the memory 5). The first type is burst mode addressing, as shown in FIG. 2. In this specific burst mode, a row 7 is closed at the same time as the address of the first memory space is offered on the bank and column address bus (‘read and close’ command in the same clock cycle as the bank address and column address). The opening of a new row 7 and the addressing of the following burst can take place while the remaining memory space of the current burst is accessed. Optimum addressing takes place if the burst length Q is greater than or equal to the latency L1 of the ‘activate’ command. In this case, the ‘read and close’ command can in fact be given at such a time that the last accessing of a memory space of the current burst is immediately followed by the first accessing of a memory space of the following burst. As shown in FIG. 2, the available memory spaces then precisely follow, whereby data can be read from or written to the memory 5 as efficiently as possible.

The second type of addressing is open-row access. This makes use of the fact that, once a row is opened, memory spaces in the same row 7 can be read from or written to without loss of access time. If the number of consecutive accesses in a row is equal to the length of the row, the loss is minimal. If Pcon is the number of samples which are consecutively read or written in a row, the following row must then be opened after Pcon clock cycles. Ppen is the number of clock cycles which are additionally required to close the current row 7 and activate the following row 7. The additionally required loss time (overhead) is then Ppen/Pcon. It therefore follows from this that the greater Pcon is, the shorter the additionally required loss time is. It is similarly possible to address consecutive memory spaces during open-row access, in a manner corresponding to burst mode addressing.

Highly efficient addressing can be achieved by using one or both of these types of addressing for writing data and then reading out data depending on the data parameters and the required processing of the data concerned.

This will now be explained in more detail with reference to an example relating to high-speed transposition of an image. This is based on an image of 32×32 samples. In FIG. 3, the image is shown as 32×32 samples s1 . . . s1024. The image is written line by line (row order) to a memory 5, but must be read in column order. The row-order write operation is carried out with the aid of the burst mode addressing described above, and the column-by-column read-out from the memory 5 is carried out by means of open-row addressing. In this case, the DRAM memory has 4096 rows, 512 columns, 4 banks and a burst length of 4.

An address of a memory space is denoted as (p, q, r), where p is the row number, q is the column number and r is the bank number. FIG. 4 shows how the samples of the image are stored in the memory 5 using the present method.

The first sample s1 is stored in memory space (1,1,1) and the following three samples s2, s3, s4 are written to the following memory spaces (1,2,1), (1,3,1) and (1,4,1) (burst length 4). During the writing of the first burst, the following row (1,:,2) can be opened, which is done by incrementing the bank number. This procedure is repeated for all 32 samples in the first rule, whereby s17 again occurs in bank 1, but with an incremented row number (2,:,1).

The first sample s33 of the second line of the image is written in the same row (1,5,1) as the first sample of the first line. The procedure is repeated for the second line (and for the remaining 30 lines) as above. Once all 32×32 samples have been written, the situation illustrated in FIG. 4 occurs. It is now clear that the first four columns are located in the same row, i.e. (1,:,1). These can therefore be read efficiently column-by-column with open-row addressing as described above. The second four columns are similarly present in the same row, i.e. (1,:,2), etc., and can therefore also be read out in an efficient manner.

The required refreshing of the data in a DRAM 5 can often interfere with the addressing (reading or writing) of the memory spaces, particularly if data are read from or written to the memory 5 in a continuous manner. The reading and writing of memory spaces must, as far as possible, be given priority, but sometimes a ‘refresh’ command needs to be given priority in order to prevent loss of data in the memory 5.

According to the present invention, use is therefore made of a priority control 10 (see also FIG. 6 which is discussed below), which has five modes, as shown in FIG. 5:

‘idle’ (11): this mode is the normal mode, to which the priority control 10 always returns;
‘refresh’ (12): this is the standard refresh mode, to which the priority control 10 is set following a low-priority refresh request;
‘init’ (13): this is an initialisation mode, to which the priority control 10 is set following activation of the memory supply, and following a change of the DRAM mode;
‘R/W controller’ (14): in this mode, memory spaces are read from the memory 5 or are written to the memory 5. An R/W controller mode is added for each addressing scheme;
‘R/W interrupt’ (15): if a high-priority refresh request is received during a read or write operation, the priority control 10 is set to this mode.

FIG. 5 shows not only the various modes, but also the transitions between them. Thus, on completion of a refresh (mode 12), the end of the initialisation (mode 13) and the end of a read or write operation (mode 14) the priority control 10 will revert to idle mode 11. At the end of a refresh in the ‘R/W interrupt’ mode 15 of the priority control 10, the latter will revert to the relevant ‘R/W control’ mode 14 to which the priority control 10 was previously set.

In the ‘idle’ mode 11, a low-priority refresh request is always handled in ‘refresh’ mode 12. Requests of this type may be submitted early, but generally these requests are made only when necessary, since the memory 5 requires a relatively large amount of power during a refresh. Low-priority refreshes never interfere with read and write operations and generally require simple handling procedures. During a read or write operation of the memory 5 (‘R/W control’ mode 14), a low-priority refresh request is handled only if the latter does not interfere with any read or write operation. If it does interfere, the priority control 10 waits for the first possible moment before switching to ‘R/W interrupt’ mode. On completion of the high-priority refresh, the priority control 10 reverts to the relevant ‘R/W control’ mode 14 in order to complete the read or write operation. High-priority refresh requests of this type therefore require special handling procedures. FIG. 6 shows the environment in-which the priority control 10 operates. The DRAM control 10 (which, inter alia, controls the addressing of the memory 5) communicates with a refresh control 17, which in turn is connected to the priority control 10.

If the priority control 10 is set to ‘idle’ mode 11, as indicated by the status signal 22, the refresh control 17 generates control signals 18 to ensure that one or more refresh cycles are carried out by the DRAM control 16. The DRAM control 16 communicates the mode of the memory 5 to the refresh control 17 by means of a refresh status signal 19.

The refresh control 17 generates a refresh request 20 for the priority control 10, which is set to ‘R/W control’ mode 14, i.e. there is a risk of data loss. As soon as the priority control 10 switches to ‘R/W interrupt’ mode 15 (as indicated by the status signal 22), the refresh control 17 in turn generates the control signals 18 for the DRAM control 16. From the refresh mode signal 19, the refresh control 17 can ascertain whether the memory is again free for read or write access. This mode forwards the refresh control 17 to the priority control 10 via the memory mode signal 21, which can indicate that the memory 5 is therefore not available for other controls.

In one example, the refresh is described for a DRAM memory 5 which requires 4096 refresh cycles every 64 msec. The strategy for carrying out the refresh is that of distributed refresh. The refresh control 17 generates control signals 18 with the aid of a counter (not shown) which generates one pulse every 15.625 μsec. If no refresh has taken place in the preceding 15.625 μsec and the priority control 10 is set to ‘idle’ mode 11, the counter pulse will produce the control signals 18. If the priority control 10 is set to ‘R/W control’ mode 14 when the counter pulse occurs, the refresh control 17 will first wait until the priority control switches to ‘R/W interrupt’ mode 15 before the control signals 18 (forced refresh) are sent to the DRAM control 16. The refresh request 18 may comprise a series of commands for the DRAM control 16, which are required in order to carry out one refresh cycle, for example implemented in a state machine. This state machine can then similarly be used to indicate to the priority control 10 that the memory 5 is not free for other controls.

The refresh strategy can of course be selected in a different way, whereby an optimum choice must be made between hardware requirements and the number of forced refreshes that take place.

1-12. (Cancelled)

13. A method for addressing a random access memory for writing data to the memory and reading data from the memory, wherein the memory includes at least:
one bank;
a plurality of rows; and
a plurality of columns, wherein the manner of writing data to the memory and the manner of reading data from the memory are carried out according to one of a first and a second addressing type, wherein the addressing type for writing and reading is selected on the basis of parameters of the data and the processing which is to be carried out on the data.

14. The method according to claim 13, further including the steps of:
checking whether the memory is busy performing a read or write operation;
waiting until the read or write operation can be interrupted when the memory is busy performing the read or write operation;
refreshing the memory row-by-row; and
continuing the interrupted read or write operation.

15. The method according to claim 14, wherein the first addressing type is burst mode addressing with a burst length of Q memory spaces, wherein performing the burst mode addressing includes the steps of:
opening a row of the memory; and
addressing Q memory spaces in that row by selecting a bank and a start column.

16. The method according to claim 15, wherein consecutive burst sequences are addressed to different banks of the at least one bank.

17. The method according to claim 16, wherein the burst length Q is greater than a latency L1 required to open the row in the memory.

18. The method according to claim 16, further including the steps of:
closing a current row;
activating a following row; and
selecting a series of memory spaces at a time when a content of memory spaces of the current row is available at an output of the memory.

19. The method according to claim 17, further including the steps of:
closing a current row;
activating a following row; and
selecting a series of memory spaces at a time when a content of memory spaces of the current row is available at an output of the memory.

20. The method according to claim 18, wherein the time is selected so that the first memory space of the following row is available immediately after the last memory space of the current row.

21. The method according to claim 15, wherein the second addressing type includes open-row addressing, wherein performing open-row addressing comprises the steps of:
opening a combination of a bank and a row; and
accessing a plurality of memory spaces in that row through sequential selection of a plurality of columns.

22. The method according to claim 13, wherein the random access memory is one of dynamic memories (DRAM), synchronous dynamic memories (SDRAM), dynamic memories with double data rate (DDR-DRAM), and Rambus memories (RDRAM).

23. The method according to claim 22, wherein the data processing includes the steps of:
transposing a data matrix;
writing the data to the memory with the aid of burst mode addressing; and
reading the data from the memory with the aid of open-row addressing.

24. An addressing device for a random access memory, wherein the memory comprises:
at least one bank;
a plurality of rows; and
a plurality of columns, wherein the addressing device is operative for selecting one of a first and a second addressing type, wherein the addressing type for writing and reading to the memory is selected on the basis of parameters of the data and the processing which is to be carried out on the data.

25. The addressing device according to claim 24, wherein the addressing device is further operative for:
checking whether the memory is busy performing a read or write operation;
waiting until the read or write operation can be interrupted when the memory is busy performing the read or write operation;
refreshing the memory row-by-row; and
continuing the interrupted read or write operation.

26. The addressing device according to claim 25, wherein the first addressing type is burst mode addressing with a burst length of Q memory spaces, wherein performing the burst mode addressing includes the steps of:
opening a row of the memory; and
addressing Q memory spaces in that row by selecting a bank and a start column.

27. The addressing device according to claim 26, wherein consecutive burst sequences are addressed to different banks of the at least one bank.

28. The addressing device according to claim 27, wherein the burst length Q is greater than a latency L1 required to open the row in the memory.

29. The addressing device according to claim 27, wherein the addressing device is further operative for:
closing a current row;
activating a following row; and
selecting a series of memory spaces at a time when a content of memory spaces of the current row is available at an output of the memory.

30. The addressing device according to claim 29, wherein the time is selected so that the first memory space of the following row is available immediately after the last memory space of the current row.

31. The addressing device according to claim 26, wherein the second addressing type comprises open-row addressing, wherein performing open-row addressing comprises the steps of:
opening a combination of a bank and a row; and
accessing a plurality of memory spaces in that row through sequential selection of a plurality of columns.

32. A random access memory including:
at least one bank;
a plurality of rows;
a plurality of columns;
a priority control linked to a refresh control; and
a memory control linked to the refresh control, wherein the priority control has at least:
an idle mode;
a read/write mode; and
a read/write interrupt mode, wherein the refresh control is arranged for a periodic transmission of a refresh request to the priority control and a dispatch of a refresh command to the memory control if the priority control is set to one of the idle mode and the read/write interrupt mode, and wherein the priority control is set to the read/write interrupt mode if a read/write operation is interrupted in the read/write mode following receipt of the refresh request.
